(19) United States
(12) Patent Application Publication
(10) Pub. No.: US 2008/0229302 A1
(43) Pub. Date: Sep. 18, 2008

(54) SYSTEM AND METHOD FOR UNIVERSAL ACCESS TO AND PROTECTION OF PERSONAL DIGITAL CONTENT

(76) Inventors: Philip A. Kufeldt, San Jose, CA (US); Andrew Wilcox, Los Gatos, CA (US)

Correspondence Address: BUCHANAN, INGERSOLL & ROONEY PC, POST OFFICE BOX 1404, ALEXANDRIA, VA, 22313-1404, US

(21) Appl. No.: 12/048,795

(22) Filed: Mar. 14, 2008

Related U.S. Application Data
(60) Provisional application No. 60/918,425, filed on Mar. 16, 2007.

(51) Int. Cl. G06F 21/00; H04L 9/32; G06F 15/16; G06F 9/44; G06F 17/30

(52) U.S. Cl. 717/173; 726/6; 709/206; 709/217; 707/204; 707/E17.009

(57) ABSTRACT

A method of accessing content on a local trusted network from trusted and untrusted environments. The method includes assigning a software system associated with the local trusted network a unique name; associating the unique name with a local address and a dynamic external address; routing client communications to the software system using the unique name; and accessing the content from trusted and/or untrusted environments with a single method.

### CROSS-REFERENCE TO RELATED APPLICATION

This application claims priority to U.S. Patent Provisional Application No. 60/918,425, filed Mar. 16, 2007, which is incorporated herein by this reference in its entirety.

### TECHNICAL FIELD

The present invention relates to a system and method for accessing protected personal content from trusted or untrusted locations in the same manner. The invention particularly describes a software system that protects personal content through disk mirroring and automatic backup and provides access to such content to arbitrary clients via an integrated web server. Client connections may originate from either trusted or untrusted environments using the same methods. In either case, content items are consistently named with globally unique identifiers, are delivered by either raw or rendered methods, and are organized by a personal portal. Client connections are encrypted and optionally password protected.

### BACKGROUND

In recent years, the consumer has seen an explosion in the amount of personal digital content in the home. Personal digital content is digital content produced, owned, or licensed by a particular entity. Such content includes music, video, photographs, traditional documents, and other data. As the number of computers and other repositories of such content has grown in the home, a need has been created to centralize this content so that it may be more conveniently accessed, managed, and backed up.

Traditionally, solutions such as Network Attached Storage (NAS) address this problem by providing a central access point in the trusted home network. Some NAS products include advanced data protection features, such as disk mirroring and automatic backup. However, NAS products require initial configuration of both the client and server before use. NAS protocols are insufficient for providing secure access from untrusted locations.

Therefore, new methods are required to address the problem of securely accessing personal content from either trusted or untrusted locations. Such new methods must include a consistent and globally unique name for content items so the access method is identical from either trusted or untrusted locations.

The consumer has also seen a number of solutions through which personal content can be stored and shared with others. In the most basic method, documents and photos are simply emailed to collaborators or interested parties. In other cases, the files are uploaded to a remote on-line sharing service, which subsequently presents the file to other users either in “raw” format (as a list of file names), or in a “rendered” format (where photographs are shown in a “picture gallery” rather than simple file names, for example).

Despite these advances in content storing and sharing, significant problems still exist for end users. In almost all cases, emailed documents are transmitted without encryption, and limits necessarily exist on email attachment size. Since the home copy is frequently the master copy, updates or edits do not propagate to remote on-line sharing services, or to former email recipients of the content. Use of remote on-line sharing services is time intensive: users must select documents, upload them, and wait for successful completion. Further, users must use different names and methods to access remote on-line sharing service content than they would use to access local content.

If users were to use an on-line copy as the master copy, other problems arise. The nominal case of accessing the document from home is penalized with download delay. Many on-line sharing services explicitly give no guarantee of file backup. Use of remote on-line sharing services may cause some users to worry about loss of control over their content, such as ability to delete or discontinue, automatic licensing of uploaded content, handling of backup tapes, inappropriate viewing by service staff, and privacy concerns in general.

There are other features of the current environment that leave room for improvement. When files are stored on a personal computer, they are very likely stored only on a single disk. Thus, failure of that disk could result in total data loss if the computer is not backed up. Automatic backup software is typically used to protect against disk failure. However, backup is still an add-on product for personal computers, and therefore is often overlooked or ignored by consumers.

In summary, there is no universal method for securely accessing, sharing, and protecting personal content stored in the home.

Therefore, there is need for solutions that address the problems of protection of and access to personal digital content.

### SUMMARY OF THE INVENTION

In accordance with one embodiment, a method of accessing content on a local trusted network from trusted and untrusted environments, the method comprises: assigning a software system associated with the local trusted network a unique name; associating the unique name with a local address and a dynamic external address; routing client communications to the software system using the unique name; and providing access to the content from trusted and/or untrusted environments with a single method, and wherein in response to assigning the unique name, the software system automatically executes the steps of: assigning the software system associated with the local trusted network; associating the unique name with the local address and the dynamic external address; routing client communications to the software system using the unique name; and providing access to the content from trusted and/or untrusted environments with a single method.

In accordance with another embodiment, a method of automatically partitioning and grouping at least one storage device comprises: partitioning each of the least one storage devices into a primary storage area partition and a backup storage area partition; combining each of the primary storage area partitions into a primary storage area, and mirroring the primary storage area partitions; combining each of the backup storage area partitions into a backup storage area and additively combining the backup storage area partitions; copying data from the primary storage area to the backup storage area such that the backup storage area data alone or in combination with the primary storage area data is sufficient to retrieve past versions of primary storage area data; and associating stored items with a user.

### BRIEF DESCRIPTION OF THE DRAWINGS

FIG. 1 is a schematic diagram illustrating the systems discovery of the external address of the router in accordance with one embodiment.

FIG. 2 is a schematic diagram illustrating the publishing of system's name and discovery of the external address and receiving acknowledgment thereof.

FIG. 3 is a schematic diagram illustrating the system instructing the router to perform port forwarding and receiving acknowledgment thereof.

FIG. 4. is a schematic diagram illustrating incoming traffic to a TCP port, which is forwarded to an integrated web server.

FIG. 5 is a schematic diagram illustrating a web file service in accordance with one embodiment.

FIG. 6 is a schematic diagram illustrating the system in accordance with another embodiment.

FIG. 7 is a schematic diagram illustrating DHCP and DNS services in accordance with one embodiment.

FIG. 8 is a schematic diagram illustrating the accessibility of print service from a local or remote location in accordance with a further embodiment.

FIG. 9 is a schematic diagram illustrating the email server capabilities in accordance with another embodiment.

FIG. 10 is a schematic diagram illustrating the user interactions with the gallery module in accordance with a further embodiment.

FIG. 11 is a schematic diagram illustrating the video module in accordance with another embodiment.

FIG. 12 is a schematic diagram illustrating the music module in accordance with a further embodiment.

FIG. 13. is a schematic diagram illustrating a personal portal in accordance with one embodiment.

FIG. 14 is a schematic diagram illustrating a system of disk partitioning in accordance with another embodiment.

### DETAILED DESCRIPTION

In accordance with one embodiment, an integrated software system that simultaneously solves the consumer problems of access, protection, and management of personal digital content has been developed having a simultaneous solution. It can be appreciated that if content is centralized in the home, then such central access service must include advanced data protection, such as disk mirroring and automatic backup in order to ensure availability of the centralized data. Conversely, a device which provides a high level of data availability will quickly be selected as the device to which access is desired. Accordingly, access to content and content protection are therefore two sides of the same problem of management of personal digital content.

### Providing Access to Personal Digital Content

In accordance with one aspect of the invention, the system software 101 allows access to personal digital content from trusted or untrusted environments. This software performs several automatic tasks and functions which, in combination, provide a universal access method and unique names (e.g., globally accessible unique names) for the consumer's personal digital content.

The system software 101 preferably resides on computer hardware that may be any standard computer, in one embodiment a personal computer, and in another, a system-on-chip type computer more suitable for consumer electronics (i.e., a stand alone unit), and in another embodiment, a virtual computer provided by virtualization software. The computer hardware and software system 101 may be located anywhere there is power and an Internet network connection, including the home, the office, or a secure, managed environment. To best realize the benefits, the consumer will place the system closest to point of use. In most cases, this is the home or office.

In order to provide a single method to access the personal digital content, the system 101 must be known by a consistent, globally accessible and unique name that can always be used by the consumer, both from trusted and untrusted environments. The system software 101 provides this feature by performing several automated tasks as described below.

In most consumer environments the trusted, local IP addresses used by personal computers and other interior devices typically reside in the 192.168.X.Y address space which, by convention, is deemed “unconnected”. The broadband connected consumer has a router device which connects the local network to the exterior broadband connection. The router has a single, external, “connected” IP address that is typically in flux, and may change as often as once per day.

In order to provide connectivity to the internal devices with unconnected addresses, the router performs the task of Network Address Translation (NAT) between the internal addresses and the external one when communicating with the broadband network. A benefit of this function is that internal devices do not need to know their associated external address, and this external address can be difficult for the internal devices to determine since several layers of NAT may be employed by the broadband provider.

This typical consumer configuration is not designed to handle incoming connections. In fact, the router performs an important security feature by blocking incoming connections that are quite likely forms of intrusion attempt.

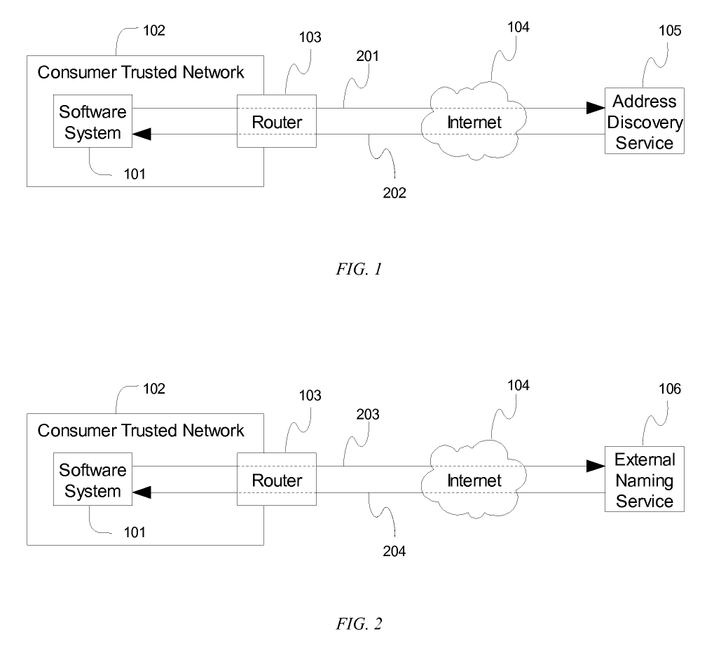

It can be appreciated that the invention therefore performs three automatic functions that allow the software system 101 to become associated with and respond to requests sent to a unique globally accessible name. First, by communicating with an external service, the system 101 determines the external IP address of the local router. This mechanism is shown in FIG. 1. The software system 101 inside the consumers trusted network 102 is connected to the Internet 104 by a router device 103. An address discovery service 105 also resides on the Internet. The software system 101 sends a message 201 to the address discovery service 105. This message is sent over a secure channel, and is password protected. The address discovery service then simply inspects the source address, which will be the router external address, and sends a reply 202 containing the external address of the router 103.

Second, as shown in FIG. 2, the software system 101 sends a registration message 203 through the Internet 104 containing its unique name and external IP address to an external naming service 106, and receives an acknowledgment 204. In a preferred embodiment, this service is implemented using the common Domain Name System (DNS).

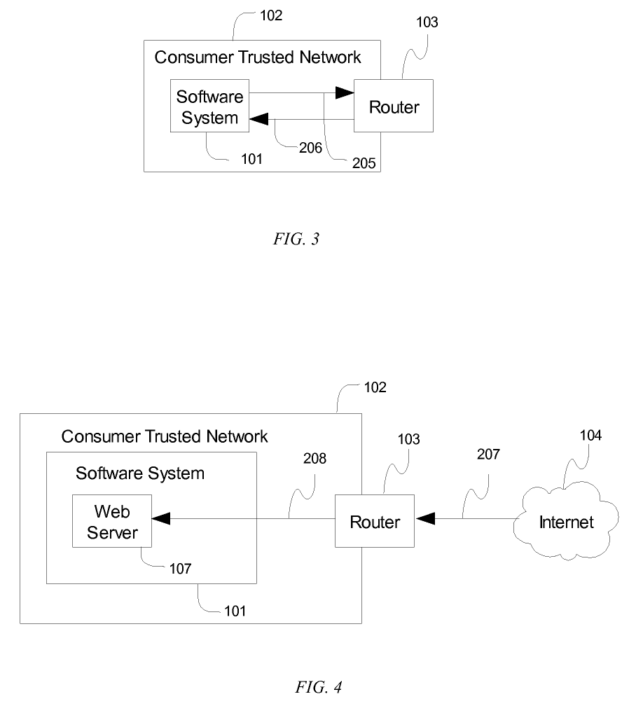

Third, as shown in FIG. 3, the software system 101 sends a message 205 and receives acknowledgment 206 from the router 103. The message 205 instructs the router 103 to accept and redirect certain types of incoming connections, such as web server connections, to the system 101. In a preferred embodiment, this function is performed by using Universal Plug and Play (UPNP) or customized router tools that perform an equivalent function.

After such port forwarding, incoming messages 207, initially directed at the router 103 are forwarded 208 to a web server 107, integrated within the software system 101, that supports encrypted or insecure connections as shown in FIG. 4. In a preferred embodiment, these connections are typically directed at TCP port 80 in the case of insecure connections, and TCP port 443 in the case of encrypted connections. Connections are authenticated via password, certificate, location, or name. Simple user name/password authentication is the easiest for consumers to understand due to its ubiquity. Based on authentication information, the web server allows access to various services and areas of files on the system.

The aspects of the invention discussed so far provides methods that allow the system 101 to accept connections on the Internet at a fixed name. In accordance with another embodiment, system software 101 that extends these methods through to personal digital content has been developed. These extensions simultaneously provide anywhere, anytime access to content items through consistent access methods and enables content items to be reached at unique globally accessible names. This is at the heart of the invention, and is discussed below.

In addition, the software system 101 also includes access to files using web based protocols. In a preferred embodiment, the web file service is the Web Distributed Authoring and Versioning (WebDAV) protocol running in a web server. WebDAV is supported in standard distributions of Windows, Mac OS/X, and variants of the Unix operating system. WebDAV uses the Hyper Text Transfer Protocol (HTTP) or its encrypted secure variant, HTTPS, as its transfer protocol, making it ideal for use through most firewall connected networks.

Because of features of the HTTP/HTTPS web protocols, local or remote clients can communicate by using the same method. For most consumers, this method is as simple as entering the unique name into a web browser whether in a trusted or untrusted location. Such consistently named network locations may be bookmarked and/or referenced by a “shortcut” folder on the desktop.

WebDAV works by encoding file read or write requests in the eXtensible Markup Language (XML) and transmitting these requests to the desired web server, which responds accordingly. Files served by the web server via WebDAV are named according to individual preference, and may be of any type.

The web file service may be supplied by stand alone server, or be integrated into the web server, as in a preferred embodiment. It can be appreciated that a good deal of the connection complexity (such as negotiating HTTPS connections and subsequent authentication in a variety of flavors) is handled by the web server. However, the web server runs at a single operating system permission (as the user “daemon” in a preferred embodiment), and is unable to switch. Yet, to be useful, the invention must support individual, protected directories. To address this difficulty, the web file service can be configured to grant access to a particular private directory to a user based on the authentication information passed to the web server. The owner of the device is given control over this permission partitioning.

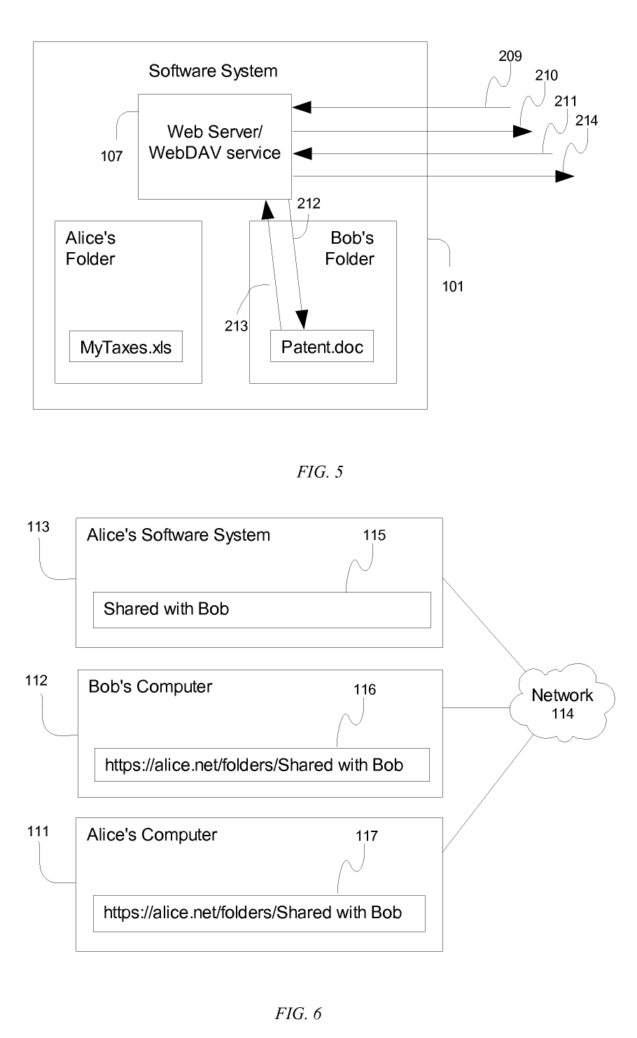

FIG. 5 shows this feature in action. An initial connection 209 is made to the software system 101 when user Bob requests access to particular personal digital content using a globally unique name, such as “https://smithfamily.org/folders/Bob/Patent.doc”. The initial message 209 includes Bob's authentication information (such as user name/password or certificate). Assuming this data is correct, a connection is established, and a message is sent to confirm this 210. Bob's device then requests 211 a particular file, “Patent.doc”. The WebDAV service then opens this file in the operating system 212 and reads the content 213, and delivers it to Bob's device 214. Because the connection was authenticated as user “Bob”, the WebDAV file service/Web Server will not allow access to user Alice's files.

The methods described so far enable users to access files from any location, whether inside of the home or from an untrusted location simply by supplying their unique location specifier, and appropriate authentication, such as a user name/password or certificate.

Therefore, a combination of functions provided by the invention enables personal digital content to have unique, globally accessible names that are a combination of a unique name (and/or a network name) registered with the external service as discussed above and a local content identifier. For simple files and other such content items, the local content identifier is equivalent to the local filename of the content item. In other cases, particularly those in which content is rendered (such as photo galleries) the local content identifier may be automatically generated. In a preferred embodiment, the concatenation of a DNS name with a local content identifier constitute a Universal Resource Identifier, or URI.

It can be appreciated that the software system 101 therefore allows users to share files in a new, convenient, and secure manner. An example depicted in FIG. 6 shows three devices connected by a network 114: Alice's computer 111, Bob's Computer 112, and Alice's Software System 113. Alice creates a user name and password for Bob on her software system 113 and also a folder on her software system 113 called “Shared with Bob” 115. Alice then gives Bob access this folder by sharing the full name of the folder (the URI) and associated user name and password for Bob on Alice's software system 113. Bob would use this information to create a folder or bookmark “shortcut” 116 on his computer 112 that referred to the “Shared with Bob” folder 115 on Alice's system 113. In this way, Alice can share her files simply by placing them in the shortcut location 117 on her computer 111. Both Alice and Bob simply see and use a regular folder icon in regular ways, and no software installation on any of their computers is necessary. The sharing is bidirectional, meaning that Bob can place files in the folder, and then Alice can see them.

In other aspects of the access features of the invention, the system 101 can provide other local network services that aid local clients in the use of the system.

In accordance with one embodiment, the system 101 implements a local network naming service, which is necessary in cases where the chosen external name of the software system cannot be translated into an IP address by local clients. By providing this feature, such functionality is assured. It should be pointed out that this network naming function is distinct from the separate external network naming service that provides the unique name. This function is provided in conjunction with a local address server, which provides dynamic or static address information to local network clients. The local naming service can also be used to provide static and dynamic network name associations for other devices as the consumer sees fit. In accordance with a preferred embodiment, the local address server is a DHCP server, and a preferred embodiment of the naming service is a DNS server. So that there are not two competing local address services, the one normally enabled on the router must be disabled.

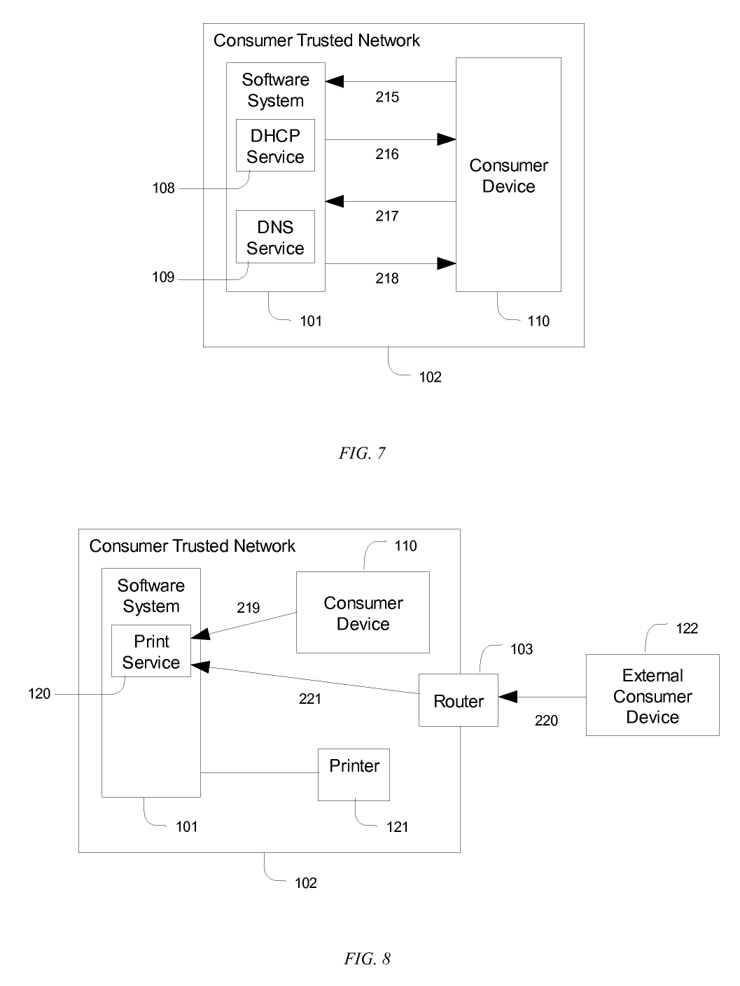

As shown in FIG. 7, when a consumer device 110 within the consumer trusted network 102 starts, it typically requests an IP address and DNS information 215. The DHCP server 108 within the software system 101 responds 216. Subsequent DNS requests 217 made by a consumer computer 110 are answered 218 by the DNS service 109 which resides in the software system 101.

In accordance with another embodiment, the system software 101 can also include a print server. As with other aspects of the invention, the printing service is available to either local or remote users. Using the system, it is possible for the consumer to print documents at home from external locations.

As shown in FIG. 8, the software system 101 contains a print service 120 and is connected to a printer 121. The local consumer device 110 configures the printer by specifying the URI of the printer, for example, http://system.smithfamily.net/printer1, and directly transmits 219 print requests to the print service 120. The external consumer device 122, for example a laptop during travel, can be configured in the same way. Due to the combination of the external naming service 106 and port forwarding on the router (FIG. 3), the external consumer device 122 print message 220 is first directed at the consumer router 103, which forwards the message 221 to the print service 120. Through this mechanism remote consumer devices can gain access to local printers.

It can be appreciated that since the system software provides a unique name, the system can also provide email server functionality. This functionality is engaged by forwarding the appropriate email ports from the router to the consumer device 110 (as shown in FIG. 3), and by enabling both an email delivery process and an email reading process on the software system. This feature will prove useful to those concerned about the privacy and disposition of their electronic mail boxes and messages.

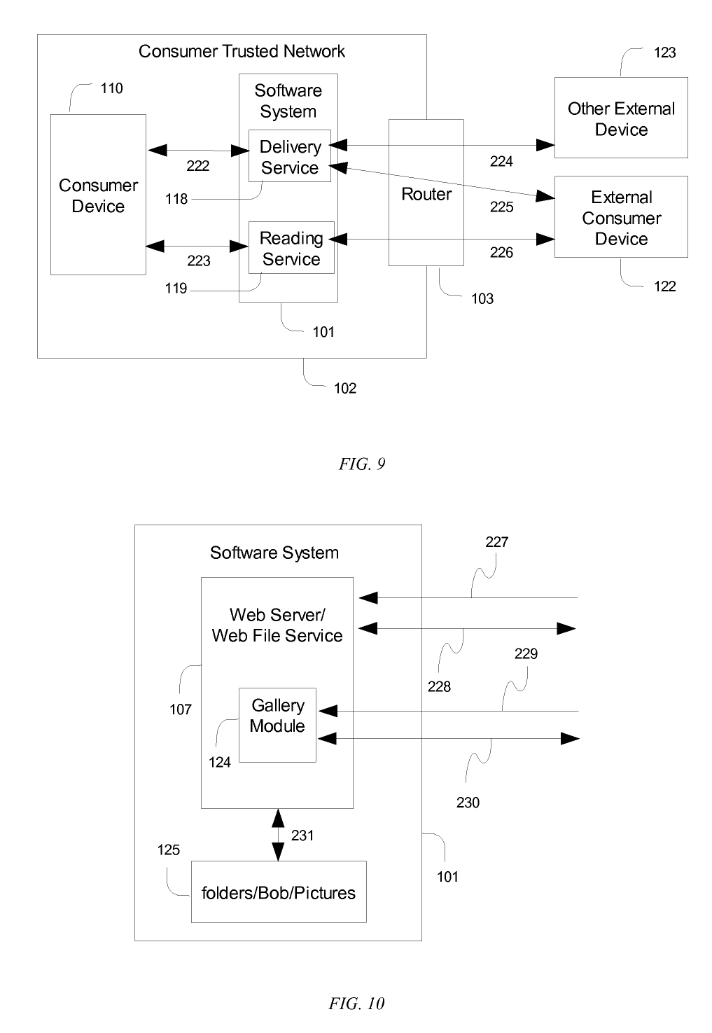

FIG. 9 shows the email server functionality in detail. The system software 101 residing in the consumer trusted network 102 contains both a delivery service module 118, and a reading service module 119. The delivery service module 118 performs the traditional functions of receiving mail from the outside world, or receiving mail from known, internal users that is to be sent to the outside world. The reading service module 119 performs the usual duties of allowing mail clients to read mail messages and informing them that new messages have arrived. The consumer device 110 located within the consumer trusted network 102 communicates 222 with the delivery service 118 to send mail, and communicates 223 with the reading service 119 to read mail. Both the delivery and reading service are contacted at their respective well-known ports at the globally accessible and unique name. There is little difference for the consumer devices 110 located externally 122 from the consumer trusted network 102. For example, the external consumer device 110 still uses the unique name of the software system 102 for communication 226 with either the reading service 119 or communication 225 with the delivery service 118. In a preferred embodiment, both of these connections utilize their secure variants. Finally, any other external devices 123 use the unique name to communicate 224 with the delivery service in order to deliver email to users of the software system 101. The software system 101 has instructed the router to forward the appropriate reading and delivery ports (as in FIG. 3) so that external hosts may communicate 224, 225, 226 with the services residing inside the consumer trusted network. In a preferred embodiment, the system reading service is an IMAP server and the delivery service an SMTP server. In accordance with an embodiment, the IMAP server can be a dovecot IMAP server, and the SMTP server can be qmail SMTP server.

As discussed, the access aspect of the invention provides methods to securely access and share personal digital content. While appropriate for traditional file access, raw file access and sharing is often not the preferred means of accessing or sharing personal digital content. Often, consumers wish to access or share their content at a higher level. For example, sharing digital photographs as a gallery or slide show rather than as a list of files.

Certain operating systems have the capability to use a list of files to generate a gallery or slide show, but this capability is widely variant amongst operating systems. Support of single, web-enabled media-specific access methods in the software system provides a simple method with which personal digital content may be viewed independent of viewing platform.

In the case of digital images, the system 101 as described herein supports such rendered access and sharing through a gallery software module 124 as shown in FIG. 10. The consumer, from either trusted or untrusted location, connects 227 to the software system 101 at the globally accessible and unique name, and provides appropriate user name/password or certificate authentication to the web server. The consumer then selects 229 the upload image tool within the gallery software module 124, and uses it to select local images they wish to share or access on the software system. When the images are selected, the consumer accepts the list, and the images are uploaded 230 to the software system and placed 231 in the appropriate user's directory 125.

Alternatively, images may be copied to the software system 101 through the web file service previously discussed. The software system 101 periodically inspects 231 newly arrived files in a particular location 125. If the files are found to be images, they are copied to the gallery module 124 as though the user had uploaded them as discussed in the previous step. The consumer may elect to disable this feature.

Once the images are uploaded to the proper location 125, the gallery module 124 generates thumbnail views of the image and, if necessary, also generates medium sized images. The resulting albums of images may be named, ordered, and representative pictures for each album selected. Images are named, deleted, comments added, and images are moved between different albums as desired by the consumer. Subsequent requests to view the gallery module show the current state of galleries, images, names, comments, and the like. The gallery is rendered as a simple web page populated with thumbnail images which are themselves links to progressively larger versions of the image. The gallery files can alternatively be viewed, modified, or uploaded through the web file service. In a preferred embodiment, the gallery module 124 is the popular gallery web software available from gallery.menato.com

In the case of video files, the invention supports rendered access to video though a video software module 126 as shown in FIG. 11.

The consumer first authenticates with the software system 232 as usual. Files are uploaded 233 to the software system 232 through use of the web file service and placed 238 in a standard location 127. As in other examples, the consumer may be located in either a trusted or an untrusted environment. When the consumer connects 234 to the video module 126, the module scans 237 the appropriate directory 127, and presents 235 a list of available video from which to choose. In a preferred embodiment, the list of available video is encoded as specified in the UPnP AV Content Directory standard. Next, a dialog 236 begins between the consumer and the video module 126 where the user requests, receives, and controls playback of particular content. In a preferred embodiment, this dialog is UPnP AV media renderer and media server compliant. In another embodiment, the dialog is Real Time Streaming Protocol (RTSP) and Real-time Transport Protocol (RTP). In another embodiment, this dialog is controlled by the consumer through an “Active-X” control, which sends a list of available media and starts an appropriate player on the remote device (not shown) the consumer is using.

To facilitate viewing on devices separated by slower network connections or equipped with small displays, certain media can be optionally “down sampled” so that the bandwidth or resolution required are less than that of the native copy kept by the system. In this way, content is automatically and dynamically scaled to fit the capabilities of accessing device. This scaling is performed on a per connection basis. Returning to FIG. 11, message 234 informs the video module 126 of the capabilities of the remote device, and during the streaming session 236 the video module 126 performs the appropriate scaling.

Alternatively, video content is statically down sampled based on the maximum network upload speed available to the software system 101. Video content can be down sampled in various ways, including reduction in quality, frame rate, or frame size. The video module 126 produces a series of alternative down sampled versions of the original media based on media players likely to access the down sampled content. When a remote device (or player) connects to the video module and requests content, the video module 126 substitutes the most optimal down sampled version based on the playback capabilities of the device.

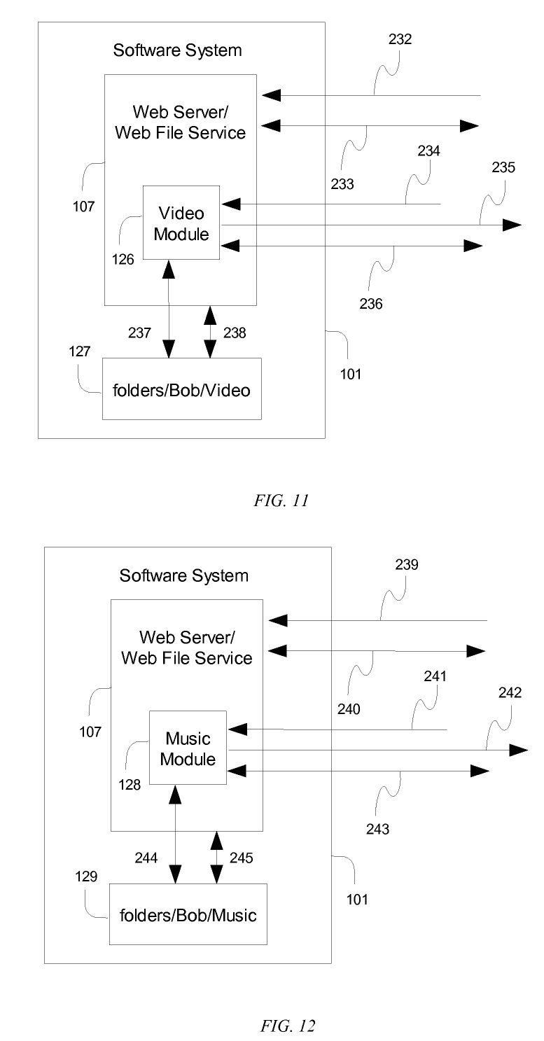

It can be appreciated that the treatment of music files is similar to video files. In order to enjoy rendered music content, the consumer interacts with the music module as shown in FIG. 12. As in other applications, the consumer first authenticates 239 with the web server 107. Music files are uploaded 240 through the web file service 107 and are placed 245 in the appropriate location 129 for a particular user. When the consumer requests 241 playback, the music module scans 244 the appropriate music directory 129, and a list of media is returned 242 to the consumers rendering device. The consumer then begins a dialog 243 of selecting particular media and enjoying playback. In a preferred embodiment, the list of media and playback session are the various UPnP standards for content directory, media server, and media renderer.

It should be mentioned that in the case of documents, such as PDF files, Excel spreadsheets, etc., existing file name extension match technology allows devices to launch the appropriate applications and pass the file to them. Document viewing is typically serialized and slow, therefore existing technology paired with the invention is sufficient. Consumers are able to use the familiar folder/file browsing paradigm, and click to open selected documents.

In the final aspect of access to personal digital content, the method and system combines the above features of a unique name, a web server, secure file access, the display of rendered content, and storage of personal content with that of a personal portal. A personal portal is a “home portal” web page on which a unified view of personal digital content and other content of interest is shown. The personal portal is customized according to individual consumer preference, such as including local weather or news headlines, favorite or recent pictures, turning on a family calendar, and other such portal functions.

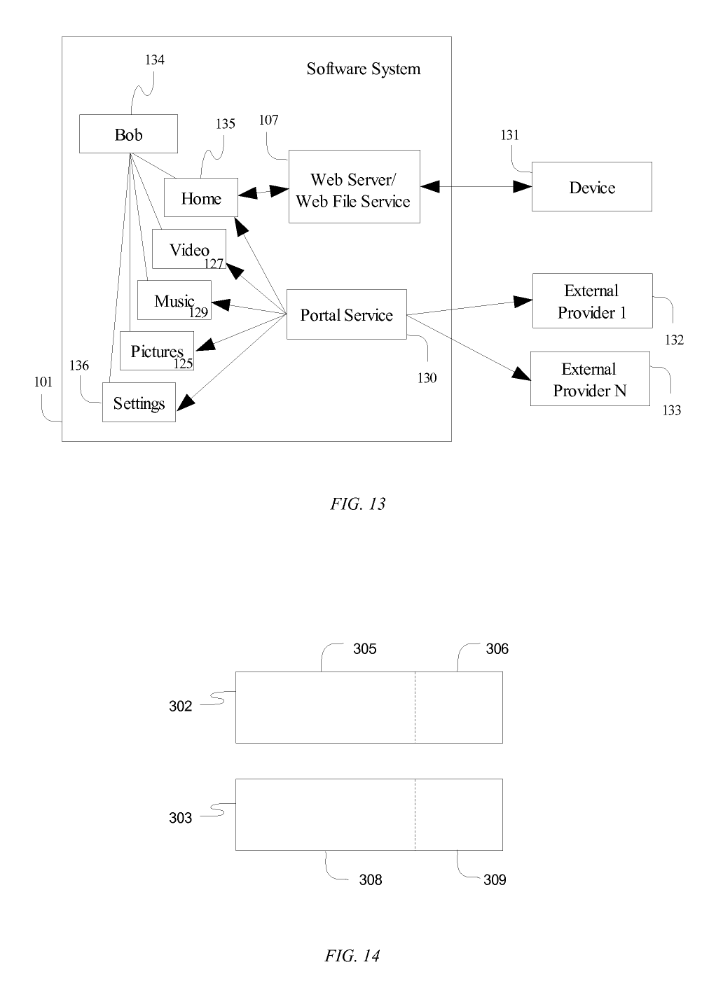

There are several aspects of the personal portal. The portal is a combination of automated tasks and functions that allow the consumer to specify internal and external content to be continuously collected, stored, and ultimately rendered on a web page. Therefore, the portal is a single, integrated entity with which consumers interact to view both internal and external aspects of their digital lives. Use of a personal portal that includes personal digital content encourages consolidation of content. Such consolidation of content removes duplication, and allows current versions of content to be easily found. Most importantly, the portal provides universal access by use of the unique name. The consumer finds that their personalized portal, complete with personal digital content, contains continuously updated information, and is available from anywhere. This functionality is show in FIG. 13.

The automated tasks of the portal service 130 regularly inspect the settings 136 of a particular user of the software system 101, in this case user Bob. The settings dictate which external providers 132, 133 should be queried for content updates. The portal service 130 also examines the personal digital content within the user's home directory 134, if specified in the settings 136. As we have seen, such content is stored in the users video 127, music 129, and pictures 125 folders. If updates are found, the portal service 130 retrieves said updates, and publishes these changes to the users home page 135. The user views their home page by using an appropriate viewing device 131 to connect to the web server 107 within the software system 101. The home page also includes static content, such as links to the file portion of the web file service, and links to software system control functions, as explained later. The web connection is authenticated as we have seen in previous descriptions.

In one embodiment, the consumer settings 136 include a list of RSS feeds, such as news headlines, weather forecasts, entertainment news, or any available feed. In another embodiment, automatic functions performed by the portal software allow the users home page 135 to contain certain live content, such as microphones, temperature sensors, or video cameras, appliances, or any device supporting the various UPnP standards. In another embodiment, the portal also provides gateway services to Personal Video Recorders, such as a TiVo® unit that allows for access to such recorded content on the home page.

In another aspect of the portal software, the portal service itself can provide RSS feeds to other portals, such as My Yahoo!. In this case, the consumer would log on to another portal, such as a My Yahoo!, and would use personalization features of that portal to add personal content from RSS feeds provided by the system software. In this way, recent photographs and current security camera photos may be viewed on the more familiar My Yahoo! Portal experience.

### Protecting Personal Digital Content

It can be appreciated that in accordance with another aspect, a method and system of protecting personal digital content is disclosed, which involves use of disk mirroring and automatic backup technologies to protect personal digital content therefore providing a higher level of availability of such content to the consumer. These functions are critical due to the relatively new phenomenon of the economic and emotional value of personal digital content.

Consumers typically store their personal digital content on their home or notebook personal computer. The vast majority of these machines have a single disk drive. If this disk fails, at the very least, the consumer will experience an interruption in computing service. The consumer will also loose all new data stored on the disk since the last backup was made. At the worst, the consumer will loose all data on the disk if no backup has ever been made.

Disk mirroring is the technique of keeping a set of more than one disk (or other suitable data storage mediums) in a state of synchronization at all times. Each write operation is performed to each disk in a set. Because they are in a state of synchronization, read operations may be directed to any disk in a set.

Server computers employed by larger corporate enterprises regularly use disk mirroring to provide a higher level of availability to client applications. With disk mirroring, if a single drive fails, the system software can continue to provide uninterrupted access to the data on another disk in the set. Often, a spare drive is automatically recruited to become a new member of the set. Such spare drives have already been initialized and designated as spares. When a new disk is added to the set, all the data in the set is copied to it over a period of time. When this mirror synchronization is complete, the spare disk becomes a full-fledged member of the set. In this way, even in the event of disk failure in the smallest redundant set with two disks, data resides on a single disk for only a short period of time. This dramatically reduces the chances of loss of availability to data due to disk failure.

In accordance with another aspect, the method and system uses, as a foundation, these same disk mirroring techniques so that a higher level of availability may be realized by the consumer. In accordance with one embodiment, additional system software that performs several tasks without user intervention can be implemented. These automatic tasks and functions are designed to increase the effectiveness and convenience of disk mirroring technology, which is necessary in order for the technology to be useful by the consumer. In accordance with another embodiment, a disk partitioning method can be employed, which allows for an internal, automatic backup of the data within the system software. It can be appreciated that all of these functions and tasks occur with a minimum of user involvement, and are implemented within a storage module.

The state of the disk mirror is communicated to the consumer is an easy to understand way. In a preferred embodiment, it is represented by light emitting diodes (LED) located on the system. When the mirror is in a normal, synchronized state, all disk lights are green. If synchronization is in process, the source disk is represented by a blinking green light, and the target is represented by a yellow light. If a disk has failed or has been removed, it is represented by red light. It can be appreciated that the system and method as described herein does not depend on complicated notification or GUI tools.

The storage module recognizes the addition of a new storage device or disk by way of notification from the operating system. In response to this notification, the module inspects the storage device or disk. If the storage device or disk is of acceptable capacity, the system partitions the storage device or disk into several distinct regions, and more preferably two distinct regions. If the storage device or disk is not of acceptable capacity, the LED light blinks a particular combination to notify the user of this fact. The partitioning establishes separate areas of the storage device or disk for the operating system, consumer content, and content backup. In accordance with an alternative embodiment, the operating system files can be stored in the consumer content partition.

The partitions are defined as follows. The new backup area partition 309 size is set according to the following formula, expressed as a fraction of storage size: 1/(N+1), where N is the number of storage devices (e.g., disks) in the mirrored set. In a preferred embodiment, two storage devices (or disks) are used in the mirrored set, so the size of the backup partition would be one-third the size of the storage device (or disk). The size of the new storage device (e.g. disk) 303 consumer content partition 308 is set to the remaining storage space. Returning again to a preferred embodiment with two storage devices (disks), the consumer content partition would be about two thirds of the size of the storage device. This layout is depicted in FIG. 14.

Once partitioning is complete, the storage module adds new consumer content partition 308 to the consumer content mirrored set, and enables synchronization such that new disk 303 partition 308 is made identical to existing disk 302 partition 305. In a preferred embodiment, the mirrored sets are equivalent to RAID-1 mirrored sets.

The content backup partition is handled in a substantially different manner than in traditional server computer installations. The storage module combines the new content backup partition with the existing content backup partitions to form an additive disk container. That is, the usable size of the set of content backup partitions is the sum of the pieces. By way of comparison, the mirrored set usable size is no larger than the smallest piece of the set. This approach is taken to ensure that enough space is available for content backup without addition of external tape or disk storage. Requiring the user to add storage for backup presents both a technological and economic hurdle that the system avoids, albeit with a penalty in usable content space. In a preferred embodiment, the backup area is equivalent to a RAID-0 striped volume, or a simple concatenation of all backup partitions.

Because of the automatic partitioning and synchronization functions, the storage module therefore provides a novel way to increase the quantity of storage. The consumer removes one disk, and replaces it with a larger disk. The addition of the new disk will cause said automatic partitioning and mirror synchronizations to occur. It can be appreciated that the consumer content partition and content backup data partition on the new drive will be larger than on the existing drive.

When the synchronizations have completed, as indicated to the user by a change in LED state, the user replaces the next disk, and so forth, until just one of the old drives remain. The user replaces the last existing disk with another new disk of larger size. The same automatic partitioning and mirror synchronization then occurs for the last new disk. When complete, the storage module recognizes that all partitions in the set are now larger in size than the corresponding file system, and automatically expands the size of the consumer content file system contained in the consumer content mirrored set. In a preferred embodiment, two or three drives in a mirror set is sufficient to gain protection from disk failure.

Because the content backup partitions are striped or concatenated, it should be obvious to one of skill in the art that removal or failure of one of the disks causes a total loss of the file system in the consumer backup partition. Therefore, at the completion of disk synchronizations that occur when a new disk is added, the storage module reconstructs a new backup file system on the content backup partition, and a backup is scheduled to proceed as soon as possible.

Even when disk mirroring is employed, users can loose data due to erroneous file deletion, modification, or corruption by virus or other means. To aid in recovery from these situations, the storage module includes automatic backup tasks and functions.

Content backups proceed in the following manner. At a preferred time, the storage module makes the data in the consumer content file system available in the content backup file system. In a preferred embodiment, this is accomplished with standard Unix utilities such as tar or cpio. In a space saving version of this embodiment, the content backup file system implements compression, so that it may be of reduced size, therefore increasing the amount of space available for the consumer content partition. In an alternate preferred embodiment, the backup copy is made through file system snapshot utilities. In the case of the file system snapshot alternative, even less space need be reserved for the content backup partition.

The storage module names backups by date, and are automatically rotated on a daily, weekly, or monthly or other basis as selected by the consumer. A concatenation of the backup name with the globally accessible and unique name makes the backup files accessible either locally or remotely through mechanisms have been previously described. In a preferred embodiment, this is a URI such as “http://smithfamily.myhomeaccess.net/backups/yesterday/users/alice”.

To safeguard against catastrophe, the invention uses another technique to protect personal digital content. When an external disk is attached by the user, the storage module is notified by the operating system and automatically inspects the disk. If the disk contains no data, or is a previously used system backup disk, and has sufficient capacity, the storage module initiates a full backup of the content to the external disk without user intervention. When completed, the disk activity lights will cease. A successful completion is further indicated by the storage module with an indicator light. In a preferred embodiment, this is a slowly blinking green LED on the system disks. The consumer may then disconnect the external disk and place it in an archival location, such as safe deposit box, fireproof safe, or at a secure off-site location. With this method, personal digital content is preserved even in the event of fire or other such catastrophe.

In a related catastrophe protection method, the user may optionally subscribe to a backup service that regularly delivers specially labeled disks accompanied by prepaid return postage. In response to the consumer connecting such disk to the software system, the storage module initiates a full backup of the content to the external disk, and encrypts this content with a derivative of the consumer's password. The consumer then returns the disk to the subscription backup service provider secure in the knowledge that their content is both encrypted and off site.

The subscription backup service additionally offers a recovery service that operates as follows. In the event of a catastrophe, the consumer would contact the subscription backup service provider, and properly authenticate themselves by means of a driver's license, passport, or other such state issued identification. The backup service provider then uses the appropriate consumer stored backup image to repopulate the content backup partition on a new software system by use of a simple copy utility. The system is loaded with a standard operating system image. The system is configured to provide recovery for the consumer, and is shipped to the consumer. The consumer would then connect to the software system control GUI (graphical user interface), which has been modified as noted above so that such connection is directed to a recovery page. The GUI requests the user name and password, and passes this to the storage module. The storage module uses the same algorithm as previously used to compute a variation of the user's password. This variation is then used to decrypt the consumer's content, stored in the content backup area, and copy it to the consumer content partition. This results in recovery of consumer content to the last backup disk shipped to the subscription backup service.

The software system storage module also provides difference information relative to the last backup of the content file system. In a preferred embodiment, this can be understood as an incremental tar or backup. In another embodiment, this can be understood as the set of writes to the content file system since a particular point in time. Such content update information, encrypted by the consumers password variant, is transmitted via a network connection to a designated device. In one embodiment such devices are provided by the subscription backup provider.

In the event a recovery is needed, the backup provider places these periodic updates on the backup partition in addition to the existing backup image. The recovery process applies these updates after the main image has been restored. Multiple updates are applied in the order in which they were made. Use of updates in addition to a complete disk based backup allows the consumer to reduce data loss to a minimum, even in the event of complete catastrophe in the home.

Because the storage module can transmit periodic content updates over the network to other designated devices, in another embodiment the consumer may direct such updates to remote data services now offered by many companies, such as Amazon's® S3 disk service. In another embodiment, the consumer may direct such periodic updates to another instance of the software system, which itself implements a remote data service in the storage module.

The storage module includes a data service, which is a process that listens for network connections. In response to receiving a data service network connection, the storage module authenticates the user through standard user name and password. The remote data service and the data service provided by the storage module then exchange requested update information in the form of file names and checksum data. Based on comparison of requested file names and local files, the two processes begin exchanging data. In a preferred embodiment, this data service is implemented with the Unix standard rsync command and associated rsync daemon.

Because the data transmission rates of remote data services are relatively slow versus a locally attached disk, users may wish to use the management interface to limit network backups to select files or directories representing the most important content. This system is implemented by specifying a set of directories and files to include, and then masking said set with a second set of directories and files to exclude. In either case, the sets are specified as a list including standard regular expression syntax. In the simplest usage of this method, the directory to include is set to the root of the content file system, and the set of directories and files to exclude is left blank.

In another function performed by the storage module, in response to a new disk connection as notified by the operating system, the storage module inspects the disk. If found to contain data, the system automatically exports this data to the network under any constraints imposed by the consumer. The storage module makes this determination in the following way. An attached disk will either contain a valid partition table or an invalid one. If the partition table is valid, the storage modules examines a small amount of data at the start of each partition. This data informs the storage module of the type of file system resident in the partition. The file system type and partition is then passed to the operating system for mounting. Once mounted, it is available for inspection by the storage module. If the file system is found to contain any user data, it is presumed valid, and final disposition is left to the consumer.

### Setup and Maintenance of System Software

As discussed above, significant new capabilities in access to personal digital content and simultaneous protection of such content have been developed. Functions and methods are also provided that aid in management of such content and the various ancillary functions of the software system. This section describes these functions and methods.

In typical consumer electronics devices including traditional NAS appliances, software updates must be downloaded by the consumer. After download, the consumer must follow a specific sequence of steps in order to install the updates on the appliance or consumer electronics device. There is a chance of permanently disabling the device if any error is made. There often is no notification mechanism to inform the consumer that such important updates are available.

To alleviate such difficulties faced by the consumer, we have developed an automatic software update module within the software system. The software update module periodically checks with a trusted server to see if any updates are available. If so, the software system downloads and installs them automatically and without user intervention in periods of low or no use. The software updates come in packages that also contain scripts that run before and after the software update itself. This functionality is necessary when updates may involve system services such as the web server, which must be stopped, upgraded, and restarted. In a preferred embodiment, the package system is the “itsy package system”.

There are some occasions when consumer intervention is necessary. It can be appreciated that the software system can regularly and automatically checks various aspects of system health, such as percentage of disk space used, health of attached disk drives, CPU utilization, memory or application error, and the like. If any of these parameters or combination thereof are cause for concern or consumer intervention, the consumer is notified by a method of their choosing, including email, pager, or other portable messaging device. Upon connection to the software system, the error or warning condition is prominently displayed for the consumer along with recommended actions or solutions. The consumer, at their option, is also notified with periodic health updates even in nominal conditions.

Intervention by the consumer is necessary at the initial deployment of almost any product, and the software system is no different in this respect. So that the consumer may enjoy a simplified experience, initial setup of the system is minimal, and proceeds as follows. The initial connection to the software system is made through a web browser, either by entering a standard starting IP address, or by running a discovery program on the client computer, which subsequently launches a browser that will connect to the correct starting IP address of the software system.

The consumer will simply specify their name and user name, and assign or pick a unique name by which the software system will be known. In response to assigning the unique name, the software system automatically executes the steps of: assigning the software system associated with the local trusted network; associating the unique name with the local address and the dynamic external address; routing client communications to the software system using the unique name; and providing access to the content from trusted and/or untrusted environments with a single method. Optionally, the consumer may create additional user accounts on the system as well as modify various configuration options by which the behavior of the system can be customized.

Alternative embodiments of the invention also may be implemented as a computer program product for use with a computer system. Such implementation may include a series of computer instructions fixed either on a tangible medium, such as a computer readable media (e.g., a diskette, CD-ROM, ROM, or fixed disk), or transmittable to a computer system via a modem or other interface device, such as a communications adapter connected to a network over a medium. The medium may be either a tangible medium (e.g., optical or analog communications lines) or a medium implemented with wireless techniques (e.g., microwave, infrared or other transmission techniques). The series of computer instructions preferably embodies all or part of the functionality previously described herein with respect to the system. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web).

The above are exemplary modes of carrying out the invention and are not intended to be limiting. It will be apparent to those of ordinary skill in the art that modifications thereto can be made without departure from the spirit and scope of the invention as set forth in the following claims.

1. A method of enabling access to content on a local trusted network from trusted and untrusted environments, the method comprising:
assigning a software system associated with the local trusted network a unique name; and
in response to assigning the unique name, the software system automatically executes steps of:
associating the unique name with a local address and a dynamic external address;
routing client communications to the software system using the unique name; and
providing an access method to the content, wherein the access method is identical from either trusted and/or untrusted environments.

2. The method of claim 1, wherein the step of routing client communications to the software system further comprises instructing a router to accept and forward the client communications to the software system.

3. The method of claim 2, further comprising periodically verify the forwarding of client communications to the software system.

4. The method of claim 1, further comprising encrypting client communications.

5. The method of claim 1, further comprising:
adding and deleting users and associated authentication data;
permitting and/or denying client communications based on user name and authentication data, wherein the authenticated communications is associated with the user name; and
permitting unauthenticated client communications, wherein the client communications are not associated with a user name.

6. The method of claim 5, further comprising a storage module for storing items associated with a user.

7. The method of claim 6, further comprising a printing module, wherein the printing module is coupled to the storage module, and wherein the printing module accepts client communications to the unique name and print service, the communications including a print request and printer name, the print request stored in the storage module, and wherein the printing module in response to receiving the print request causes the print request to be sent to a specified printer

8. The method of claim 6, further comprising an email receiving module, wherein the email receiving module is coupled to the storage module, and wherein the email receiving module accepts communications to the unique name and email receiving service, the communications including a recipient and message, the message either stored in the storage module associated with the recipient or transmitted to the stated external recipient if the communications are associated with a user.

9. The method of claim 8, further comprising an email reading module, wherein the email reading module is coupled to the storage module, and wherein the email reading module accepts communications to the unique name and email reading service, the communications associated with a user, and wherein the email reading module allows the user access to the users email messages in the storage module.

10. The method of claim 6, further comprising a web module, wherein the web module is coupled to the storage module, and wherein the web module accepts communications to the unique name and web service, the communications unauthenticated or associated with a user, and wherein the web module allows access to web content items in accordance with web module settings.

11. The method of claim 6, further comprising a web file module, wherein the web file module is coupled to the storage module, and wherein the web file module accepts communications to the unique name and web file service, the communications associated with a user, and wherein the web file module allows the user read and/or write access to storage module items associated with the user, and wherein the web file module allows the user read only or read and/or write access to other storage module items in accordance with web file module settings.

12. The method of claim 6, further comprising an automatic update module, which performs the steps of:
storing a list of installed software in the storage module;
contacting a central server, and validating an identify of the central server by use of a stored public key;
downloading a current list of available software packages, versions, and dependencies;
comparing the list of installed software to the current list of software;
replacing older software packages with newer software packages; and
installing new software packages.

13. The method of claim 6, further comprising delivering messages to a user based on user notification preferences stored in the storage module.

14. The method of claim 1, further comprising:
discovering the dynamic external address by communicating with an external address discovery service;
registering the unique name and the dynamic external address with an external naming service;
periodically verifying that the dynamic external address is registered and associated with the unique name; and
registering a current external address if the external address is not registered.

15. The method of claim 1, wherein the software system contains a local address service responsive to local client communications; and
the software system contains a local naming service responsive to local client communications, which associates the unique name with the local address.

16. A method of automatically partitioning and grouping at least one storage device comprising:
partitioning each of the at least one storage devices into a primary storage area partition and a backup storage area partition;
combining each of the primary storage area partitions into a primary storage area, and mirroring the primary storage area partitions;
combining each of the backup storage area partitions into a backup storage area and additively combining the backup storage area partitions;
copying data from the primary storage area to the backup storage area such that the backup storage area data alone or in combination with the primary storage area data is sufficient to retrieve past versions of primary storage area data; and
associating stored items with a user.

17. The method of claim 16, further comprising in response to a replacement of a storage device:
partitioning the new storage device into a primary storage area partition and a backup storage area partition; and
adding the new primary storage area partition to the primary storage area.

18. The method of claim 17, further comprising:
copying the primary storage area to the primary storage area partition of the new storage device; and
combining the backup storage area partitions with the new backup storage area partition.

19. The method of claim 16, further comprising creating a copy of the primary storage area on an external storage device, wherein in response to a connection of an external storage device, the storage module copies the primary storage area data to the external storage device, and wherein the external storage device data may be encrypted in accordance with system settings.

20. The method of claim 16, further comprising:
determining a set of all writes to the primary storage area since a particular event; and
transmitting the set of writes to a separate backup service, such that the set of all writes can be combined with an external backup copy.

21. The method of claim 16, further comprising:
determining the set of modified files in the primary storage area since a particular event; and
transmitting the set of modified files to a separate backup service, such that the set of modified files can be combined with an external backup copy.

22. The method of claim 20, further comprising another computing system, where the other computing system performs the following steps utilizing a software system:
copying and storing backup data from a backup device;
receiving and storing a stream of data; and
providing access to the backup data and the stored stream of data.

23. The method of claim 22, wherein the other computing system copies the stored backup data and the stored stream of data to the backup storage area of a new software system, and upon receiving correct user authentication on the new software system:
decrypting the backup data and the stored stream of data stored in the backup storage area; and
coping the backup data and the stored stream of data to the primary storage area.
